(19) United States
(12) Patent Application Publication
(10) Pub. No.: US 2010/0303323 A1
(43) Pub. Date: Dec. 2, 2010

(54) RADIATION IMAGING APPARATUS, RADIATION IMAGING METHOD, AND PROGRAM

(75) Inventor: Kazuhiro Matsumoto, Saitama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/771,204

(22) Filed: Apr. 30, 2010

(30) Foreign Application Priority Data
Jun. 1, 2009 (JP) 2009-132428

(51) Int. Cl. G06T 7/00

(52) U.S. Cl. 382/131

(57) ABSTRACT

A radiation imaging apparatus comprising: a first and second radiation-generating units adapted to irradiate the object with first and second radiation from a first and second directions; a first radiation-detection unit adapted to detect the first radiation irradiated by the first radiation-generating unit and transmitted through the object; a second radiation-detection unit adapted to detect the second radiation irradiated by the second radiation-generating unit and transmitted through the object and the first radiation irradiated by the first radiation-generating unit and scattered by the object; a readout unit adapted to read out image information indicating a result of imaging of the object from the second radiation-detection unit; an image-analysis unit adapted to analyze the image information read out by the readout unit; and a radiation-control unit adapted to control an irradiation timing of the second radiation by the second radiation-generating unit based on an analysis result obtained by the image-analysis unit.

### BACKGROUND OF THE INVENTION

1. Field of the Invention

The present invention relates to a radiation imaging apparatus, a radiation imaging method, and a program.

2. Description of the Related Art

A radiation imaging apparatus and a radiation imaging method are known, which capture a radiation image by detecting radiation, for example, X-rays, transmitted through an object. A radiation imaging apparatus is widely used for routine health checkups and the like as well as examinations at the time of medical treatments. For example, this apparatus can capture images of regions such as alimentary canals.

There are various types of radiation imaging apparatus. For example, there is available a radiation imaging apparatus which fluoroscopes and captures an image of an object upon adjusting the position of the object placed on the top of a bed between the X-ray generator and the X-ray detection apparatus which are mounted on the two ends of a support member called a C-arm. The X-rays irradiated from the X-ray generator are transmitted through an object and strike the X-ray detection apparatus. The X-ray detection apparatus converts the X-rays which are transmitted through the object and have struck the X-ray detection apparatus into an electric signal. Executing such operation under predetermined X-ray irradiation conditions (for example, an irradiation time, an irradiation timing, and an irradiation period) can display a fluoroscopic image of the object on a display in real time. As such radiation imaging apparatus, a stationary C-arm imaging apparatus installed in an imaging room and a mobile C-arm imaging apparatus which includes wheels and is movable in a hospital are respectively disclosed in Japanese Patent Laid-Open Nos. 2005-027806 and 2005-000470.

As disclosed in Japanese Patent Laid-Open No. 2004-242873, there is known a bi-plane radiation imaging apparatus which uses two types of imaging systems (to be described later) constituting the radiation imaging apparatus disclosed in Japanese Patent Laid-Open No. 2005-027806, and systematically controls the respective imaging systems. The bi-plane radiation imaging apparatus is configured to obtain radiation images of an object from two directions by controlling two types of imaging systems, namely a front-surface imaging system which captures an image of an object from the front surface side and a side-surface imaging system which captures an image of an object from the side surface side.

As disclosed in Japanese Patent Laid-Open No. 2004-242873, for example, a bi-plane radiation imaging apparatus executes an imaging sequence by alternately controlling the irradiation timings of radiation from two types of imaging systems, namely a front-surface system and a side-surface system, to an object at a predetermined fixed period. In this imaging sequence, the irradiation timings of radiation to an object are alternately controlled at a predetermined fixed period. Alternate irradiation can prevent radiation from being scattered by an object unlike when irradiation is performed at almost the same time from the two sides. This can therefore avoid blurring or the like on images, which occurs when scattered radiation affects the respective radiation images. In addition, it is possible to capture an image of an object without increasing the imaging period by removing the influence of scattering of radiation irradiated on an object by image processing.

In another example of an imaging sequence according to a bi-plane radiation imaging apparatus, two types of imaging systems including a front-surface system and a side-surface system irradiate an object with radiation at almost the same irradiation timings, as disclosed in Japanese Patent Laid-Open No. 2000-102529. Such an imaging sequence can avoid an increase in imaging period (a decrease in the maximum number of times of imaging per unit time), which poses a problem in the above imaging sequence when the two types of imaging systems including the front-surface system and the side-surface system alternately irradiate radiation. Although the technique disclosed in Japanese Patent Laid-Open No. 2000-102529 can avoid a decrease in imaging period, the influence of scattering remains. According to Japanese Patent Laid-Open No. 2004-242873, since the two types of imaging systems including the front-surface system and the side-surface system perform radiation imaging based on a predetermined fixed period, the influence of scattering cannot be removed. For this reason, it is necessary to remove the influence of scattering in image processing.

In addition, since it is necessary to perform irradiation at a predetermined fixed period, the two types of imaging systems are associated with each other. It is therefore difficult for each imaging system to perform imaging independently. This makes it necessary to use a single radiation imaging apparatus and a single bi-plane imaging apparatus, resulting in an increase in cost. Demands have therefore arisen for a technique of combining two single radiation imaging apparatus to implement the function of a bi-plane radiation imaging apparatus.

It is, however, difficult to synchronously control the irradiation timings of radiation in a bi-plane radiation imaging apparatus including radiation imaging systems configured to perform irradiation from two different directions. For this reason, a combination of two radiation imaging apparatus including one type of imaging systems cannot perform imaging equivalent to that performed by a conventional bi-plane radiation imaging apparatus. For example, such combinations of apparatus include a combination of two mobile C-arm imaging apparatus and a combination of a stationary C-arm imaging apparatus and a mobile C-arm imaging apparatus. In many cases, radiation imaging apparatus to be combined upon setting of imaging conditions such as an imaging period need to be manufactured by the same manufacturer. That is, this technique depends on the manufacturer. It is therefore difficult to upgrade a single radiation imaging apparatus to a bi-plane radiation imaging apparatus or switch between single-plane radiation imaging and bi-plane radiation imaging. This narrows the range of choices of imaging systems. It is often necessary to use both a single radiation imaging apparatus and a bi-plane imaging apparatus, resulting in an increase in cost.

### SUMMARY OF THE INVENTION

In consideration of the above problems, the present invention provides a technique of synchronously controlling the irradiation timings of radiation in a bi-plane radiation imaging apparatus including radiation imaging systems configured to perform irradiation from two different directions. In particular, the present invention provides a technique of implementing imaging control equivalent to that performed by a conventional bi-plane radiation imaging apparatus constituted by two types of imaging systems by combining two independent radiation imaging apparatus including one type of imaging systems and applying at least one of them to the present invention.

According to one aspect of the present invention, there is provided a radiation imaging apparatus which captures a radiation image by detecting radiation transmitted through an object, the apparatus comprising:

a first radiation generating unit adapted to irradiate the object with first radiation from a first direction;

a second radiation generating unit adapted to irradiate the object with second radiation from a second direction;

a first radiation detection unit adapted to detect the first radiation irradiated by the first radiation generating unit and transmitted through the object;

a second radiation detection unit adapted to detect the second radiation irradiated by the second radiation generating unit and transmitted through the object and the first radiation irradiated by the first radiation generating unit and scattered by the object;

a readout unit adapted to read out image information indicating a result of imaging of the object from the second radiation detection unit;

an image analysis unit adapted to analyze the image information read out by the readout unit; and

a radiation control unit adapted to control an irradiation timing of the second radiation by the second radiation generating unit based on an analysis result obtained by the image analysis unit.

According to the present invention, it is possible to perform imaging equivalent to that performed by a conventional bi-plane radiation imaging apparatus by using a combination of two independent radiation imaging apparatus including one type of imaging systems. In addition, the radiation imaging apparatus to be combined need not necessarily be manufactured by the same manufacturer, and can be combined and used independently of the manufacturers. It is therefore easy to upgrade a single imaging apparatus to a bi-plane radiation imaging apparatus and easily switch between single-plane radiation imaging and bi-plane radiation imaging. This broadens the range of choices of imaging systems, and hence can reduce the cost.

Further features of the present invention will become apparent from the following description of exemplary embodiments (with reference to the attached drawings).

### BRIEF DESCRIPTION OF THE DRAWINGS

FIG. 1 is a view showing an example of the arrangement of an X-ray imaging apparatus;

FIGS. 2A and 2B are views showing an example of an X-ray irradiation state in a from of bi-plane X-ray imaging using the X-ray imaging apparatus shown in FIG. 1;

FIGS. 3A to 3G are timing charts showing an example of an operation timing in the form of the bi-plane X-ray imaging shown in FIGS. 2A and 2B;

FIGS. 4A to 4D are timing charts showing an example of an operation timing in the form of bi-plane X-ray imaging shown in FIGS. 2A and 2B; and

FIG. 5A and 5B are graphs showing an example of the image information analysis result obtained by an image analyzer.

### DESCRIPTION OF THE EMBODIMENTS

### First Embodiment

The first embodiment will be described below. The following is an example of using X-rays as radiation. However, radiation is not necessarily limited to X-rays, and may be electromagnetic waves, α-rays, β-rays, and γ-rays.

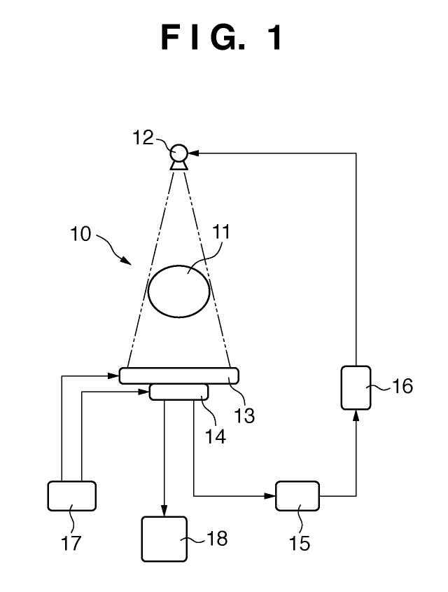

An example of the arrangement of an X-ray imaging apparatus will be described with reference to FIG. 1. An X-ray emission tube 12 functions as a radiation generating unit, and irradiates an object 11 (for example, a human body) with X-rays. An X-ray detector 13 functions as a radiation detection unit, and detects X-rays transmitted through the object. The X-ray detector 13 to be used is obtained by, for example, stacking a phosphor on a two-dimensional photoelectric conversion element made of amorphous silicon. The X-rays that have reached the X-ray detector 13 cause the phosphor to emit light. The light emitted by the phosphor that has reached each pixel constituting the two-dimensional photoelectric conversion element is converted into an electric signal corresponding to the amount of light. A readout circuit 14 functions as an electric signal readout unit, and reads out the electric signal converted by the X-ray detector 13 as image information. The readout image information of a radiation image is transmitted to an image display 18 such as a display and visualized.

On the other hand, the readout image information is transmitted to an image analyzer 15 as well as the image display 18. The image analyzer 15 functions as an image analysis unit, and analyzes image information by various kinds of analysis techniques. An X-ray controller 16 functions as a radiation control unit, and controls the irradiation of X-rays from the X-ray emission tube 12 by setting the irradiation timing of X-rays irradiated from the X-ray emission tube 12. A gain switch 17 functions as a gain switching unit (sensitivity switching unit), and switches the magnitudes of gains (sensitivities), namely the detection gain (detection sensitivity) of the X-ray detector 13, which is the amplification value (sensitivity) of an electric signal, and the readout gain (readout sensitivity) of the readout circuit 14. Switching of these gains (sensitivities) will be described later in the third embodiment.

An X-ray imaging apparatus 10 includes one or two or more computers. The computer includes, for example, a main controller such as a CPU and storage units such as a ROM (Read Only Memory) and a RAM (Random Access Memory). The computer may also include a communication unit such as a network card and input/output units such as a keyboard, mouse, touch panel, and display. Note that these components are connected to each other via a bus and the like. The main controller controls the components by executing programs stored in the storage unit.

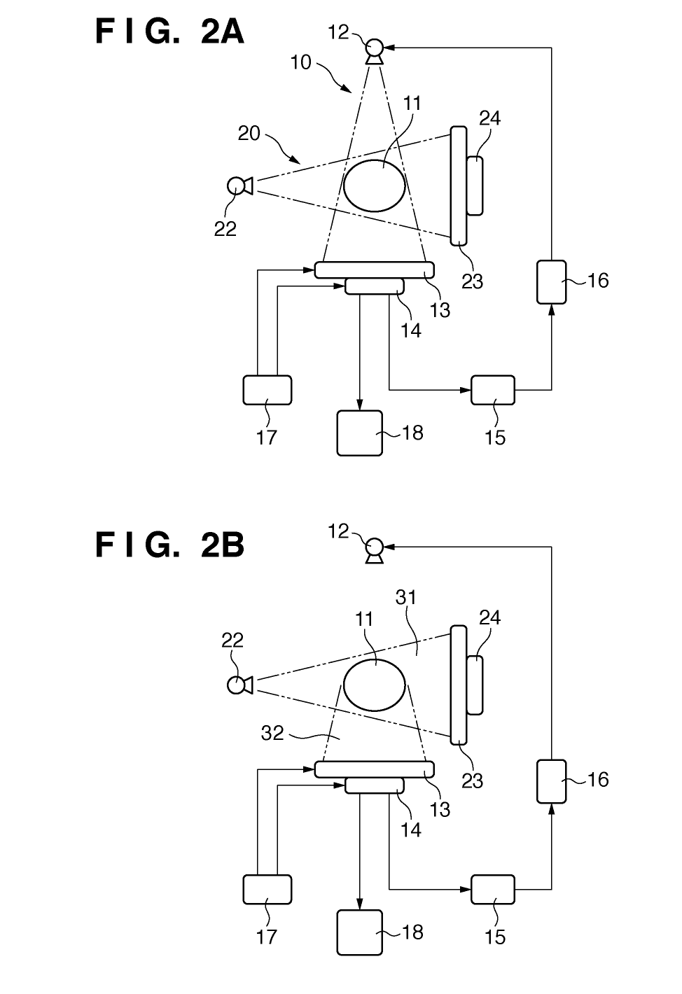

An embodiment in which X-ray imaging apparatus are combined will be described with reference to FIGS. 2A and 2B. With respect to the object 11, an independent first X-ray imaging apparatus 20 is placed as a side-surface imaging system, and the second X-ray imaging apparatus 10 according to this embodiment is placed as a front-surface imaging system. Referring to FIGS. 2A and 2B, the radiation irradiated from the side-surface imaging system (the first direction) is the first radiation, and the radiation irradiated from the front-surface imaging system (the second direction) is the second radiation. Like the second X-ray imaging apparatus 10, the first X-ray imaging apparatus 20 includes an X-ray emission tube 22 functioning as the first radiation generating unit for irradiating the first radiation, an X-ray detector 23 functioning as the first radiation detection unit, and a readout circuit 24 functioning as a readout unit. As shown in FIG. 1, the second X-ray imaging apparatus 10 includes the X-ray emission tube 12 functioning as the second radiation generating unit for irradiating the second radiation, the X-ray detector 13 functioning as the second radiation detecting unit, and the readout circuit 14 functioning as the electric signal readout unit. The second X-ray imaging apparatus 10 also includes the image analyzer 15 functioning as the second image analysis unit and the X-ray controller 16 functioning as a radiation control unit.

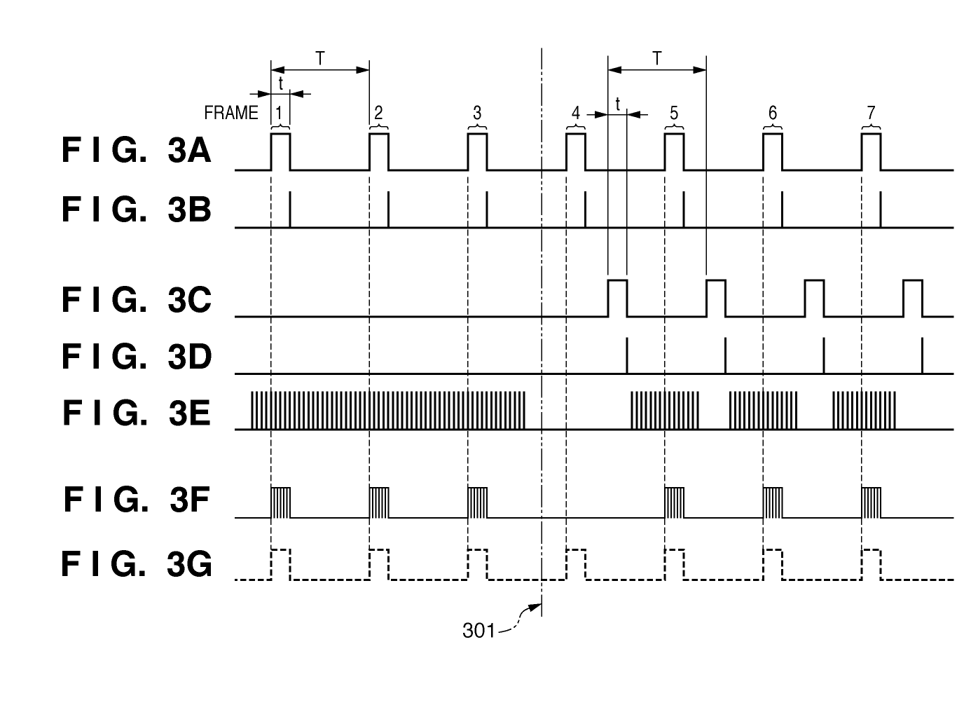

Bi-plane X-ray imaging operation according to this embodiment will be described next with reference to FIGS. 2A and 2B and FIGS. 3A to 3G. FIG. 3A shows the irradiation timing of pulse x-rays (first radiation) irradiated from the X-ray emission tube 22. FIG. 3B shows the readout timing of image information by the readout circuit 24. FIG. 3C shows the output timing of pulse X-rays (second radiation) irradiated from the X-ray emission tube 12. FIG. 3D shows the readout timing of image information in the first readout mode of the readout circuit 14. FIG. 3E shows the readout timing of image information in the second readout mode of the readout circuit 14. FIG. 3F shows the readout result of image information in the second readout mode of the readout circuit 14. FIG. 3G shows the analysis result of FIG. 3F obtained by the image analyzer 15. This indicates the prediction of pulse X-rays irradiated from the X-ray emission tube 22. In this case, the readout timing of image information in the second readout mode of the readout circuit 14 shown in FIG. 3E is a period sufficiently shorter than the irradiation time and irradiation interval of pulse X-rays irradiated from the X-ray emission tube 22 shown in FIG. 3A.

First of all, the X-ray emission tube 22 irradiates pulse X-rays (FIG. 3A) with the irradiation time t and the irradiation interval T, while the X-ray emission tube 12 irradiates no pulse X-rays, and transmitted X-rays 31 transmitted through the object 11 strike the X-ray detector 23 (FIG. 2B). After the end of the irradiation of pulse X-rays, the readout circuit 24 reads out image information in synchronism with the irradiation of pulse X-rays (FIG. 3B). At the same time, the readout circuit 14 reads out the X-rays striking the X-ray detector 13 in the second readout mode as image information (FIG. 3E). As shown in FIG. 2B, the image information read out by the readout circuit 14 is those of the X-rays irradiated by the X-ray emission tube 22 and scattered by the object 11 which are detected as scattered X-rays 32 striking the X-ray detector 13. In this case, in the second readout mode of the readout circuit 14, integration processing is performed for an electric signal read out as image information, every time an electric signal is read out. That is, the readout electric signal can be used as information (X-ray presence/absence detection information) to eventually detect the presence/absence of the scattered X-rays 32 striking the X-ray detector 13, instead of image information. Integrating this electric signal makes it possible to accurately read out the scattered X-rays 32 weaker than the transmitted X-rays 31. If the irradiation time and irradiation interval as the irradiation conditions for pulse X-rays irradiated from the X-ray emission tube 22 are constant, it is possible to predict irradiation conditions for pulse X-rays from the X-ray emission tube 22 based on the X-ray presence/absence detection information indicated by FIG. 3F, as shown in FIG. 3G, even if the irradiation conditions are unknown.

The image analyzer 15 predicts the irradiation time and irradiation timing of pulse X-rays at the fourth and subsequent frames (the right side of a chain double-dashed line 301 in FIGS. 3A to 3G), which are irradiated from the X-ray emission tube 22, based on the readout results of the first to third frames (the left side of the chain double-dashed line 301 in FIGS. 3A to 3G) by the readout circuit 14. The X-ray controller 16 sets an irradiation time and irradiation timing for X-rays from the X-ray emission tube 12 based on the predicted irradiation time and irradiation timing for X-rays so as to prevent the irradiation of pulse X-rays from the X-ray emission tube 12 from overlapping the irradiation of pulse X-rays from the X-ray emission tube 22. As shown in FIG. 3C, the X-ray emission tube 12 then irradiates pulse X-rays under the conditions of the set an irradiation time and irradiation timing for pulse X-rays. On the other hand, as shown in FIG. 3D, the readout circuit 14 reads out electric signals as image information in the first readout mode. That is, at the fourth and subsequent frames, the irradiation of pulse X-rays from the X-ray emission tube 12 and the irradiation of pulse X-rays from the X-ray emission tube 22 are alternately and synchronously controlled, and the readout circuit 14 and the readout circuit 24 alternately read out image information of the object 11. In this case, the image analyzer 15 needs to accurately predict the irradiation time and irradiation timing of pulse X-rays irradiated from the X-ray emission tube 22. If the irradiation period of pulse X-rays irradiated from the X-ray emission tube 22 is on the order of 1 ms, the readout period in the second readout mode of the readout circuit 14 can be on the order of about 1 μs. However, it is expected to read out information at a period at least ½ or less the irradiation period of pulse X-rays irradiated from the X-ray emission tube 22.

Re-setting of the irradiation time and irradiation timing for pulse X-rays from the X-ray emission tube 12 will be described next. During bi-plane X-ray imaging (the right side of the chain double-dashed line 301 in FIGS. 3A to 3G), the readout circuit 14 reads out image information in the second readout mode in the interval from the instant image information is read out in the first readout mode to the instant the next irradiation of pulse X-rays from the X-ray emission tube 12 starts. Repeating this operation will reveal, based on the readout results obtained by the readout circuit 14, whether the irradiation conditions (the irradiation time and the irradiation timing) for pulse X-rays from the X-ray emission tube 22 have changed. If the variations of the irradiation conditions for pulse X-rays from the X-ray emission tube 22 fall within predetermined constant values, this apparatus determines that the irradiation conditions have not changed, and maintains the current irradiation conditions for pulse X-rays from the X-ray emission tube 12. If the variations of the irradiation conditions exceed the predetermined constant values, the apparatus determines that the irradiation conditions have changed. If the irradiation conditions have changed, the image analyzer 15 predicts the irradiation time and irradiation timing of pulse X-rays irradiated from the X-ray emission tube 22 again based on the readout result obtained by the readout circuit 14. The X-ray controller 16 re-sets an irradiation time and irradiation timing for pulse X-rays from the X-ray emission tube 12 based on the newly predicted irradiation conditions of X-rays from the X-ray emission tube 22 so as to prevent the irradiation of pulse X-rays from the X-ray emission tube 12 from overlapping the irradiation of pulse X-rays from the X-ray emission tube 22. In this manner, the apparatus determines irradiation conditions for the second radiation based on irradiation conditions for the first radiation.

According to this embodiment, a combination of two independent radiation imaging apparatus including one type of imaging systems can perform imaging equivalent to that performed by a conventional bi-plane radiation imaging apparatus. In addition, the radiation imaging apparatus to be combined need not necessarily be manufactured by the same manufacturer, and can be combined and used independently of the manufacturers. This facilitates upgrading from a single imaging apparatus to a bi-plane radiation imaging apparatus and allows easy switching between single-plane radiation imaging and bi-plane radiation imaging, thereby broadening the range of choices of imaging systems.

### Second Embodiment

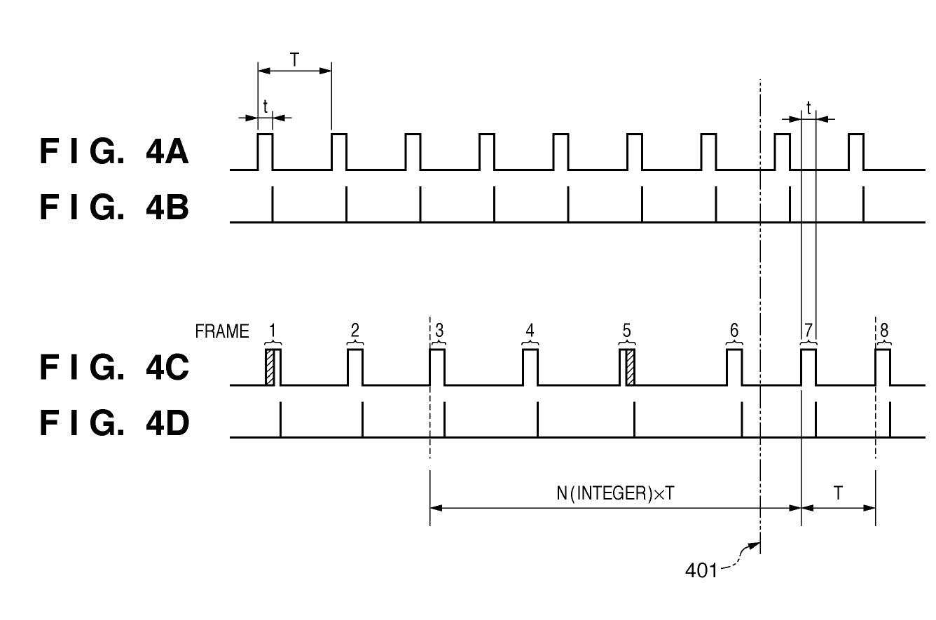

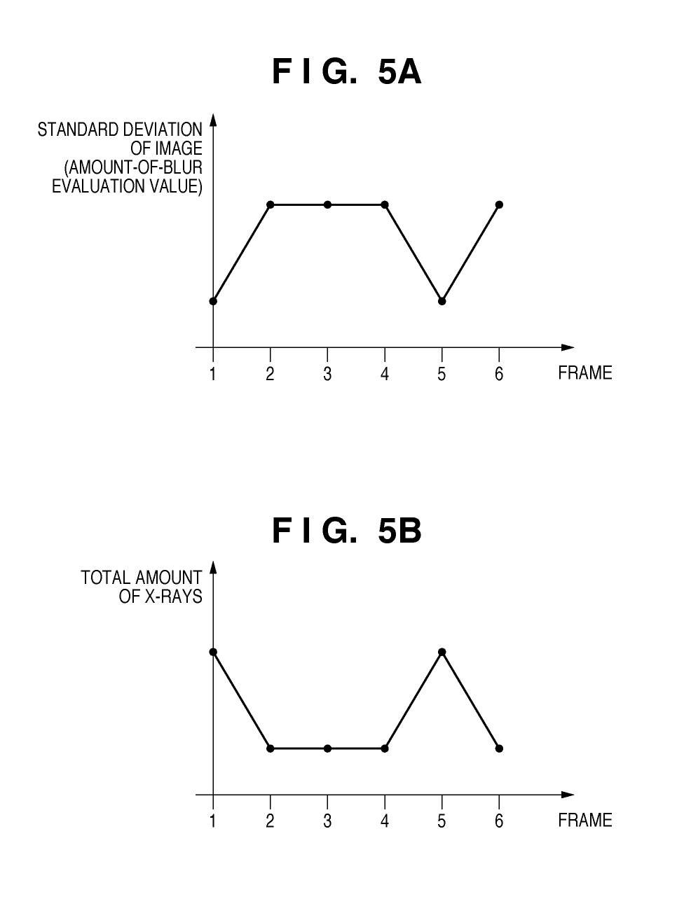

Another example of the bi-plane X-ray imaging operation according to the present invention will be described with reference to FIGS. 1, 2A, and 2B described in the first embodiment and FIGS. 4A to 4D and 5A according to the second embodiment. FIG. 4A shows the irradiation timing of pulse X-rays (first radiation) irradiated from an X-ray emission tube 22. FIG. 4B shows the readout timing of image information by a readout circuit 24. FIG. 4C shows the irradiation timing of pulse X-rays (second radiation) irradiated from an X-ray emission tube 12. FIG. 4D shows the readout timing of image information by a readout circuit 14. First of all, a bi-plane X-ray imaging apparatus including a second X-ray imaging apparatus 10 and a first X-ray imaging apparatus 20 performs X-ray imaging at an arbitrary X-ray irradiation timing. In this case, the irradiation time and irradiation interval as irradiation conditions for pulse X-rays from the X-ray emission tube 12 are set to be same as the irradiation conditions (the irradiation time and irradiation interval) for pulse X-rays from the X-ray emission tube 22 which are known in advance. The operator sets these irradiation conditions by using an input unit (not shown) such as a touch panel. When the X-ray emission tube 12 and the X-ray emission tube 22 irradiate pulse X-rays under the irradiation conditions of a set irradiation time t and a set irradiation interval T, the transmitted X-rays transmitted through an object 11 strike an X-ray detector 13 and an X-ray detector 23. After the end of the irradiation of X-rays, the readout circuit 14 and the readout circuit 24 read out image information in synchronism with the irradiation of pulse X-rays.

In this case, as only the irradiation interval of pulse X-rays irradiated from the X-ray emission tube 12 gradually increase during the above bi-plane X-ray imaging, there occurs a period in which the irradiation of pulse X-rays from the X-ray emission tube 12 overlaps the irradiation of pulse X-rays from the X-ray emission tube 22, and a period in which they do not overlap. In a period in which the irradiation of pulse X-rays from one tube overlaps that from the other tube, the image information read out by the readout circuit 14 is detected as the sum of the transmitted X-rays emitted from the X-ray emission tube 12 and transmitted through the object 11 and the scattered X-rays 32, of the X-rays irradiated from the X-ray emission tube 22, which are scattered by the object 11. The irradiation interval of pulse X-rays irradiated from the X-ray emission tube 12 gradually increases from first frame to the sixth frame (the left side of a chain double-dashed line 401 in FIGS. 4A to 4D). Periods in which the irradiation of pulse X-rays from the X-ray emission tube 12 overlaps the irradiation of pulse X-rays from the X-ray emission tube 22 are the periods indicated by the hatched portions of the irradiation intervals of pulse X-rays from the X-ray emission tube 12 at the first and fifth frames. The image analyzer 15 then calculates the amount-of-blur evaluation value of the image for each frame from each piece of image information at the first to sixth frames read out by the readout circuit 14. In this case, various amount-of-blur evaluation methods are conceivable. This embodiment calculates, as an amount-of-blur evaluation value, a standard deviation in the effective imaging range of an image. According to this evaluation method, as the standard deviation of an image decreases, the amount of blur is evaluated as large.

Referring to FIG. 4C, periods in which the irradiation of pulse X-rays from the X-ray emission tube 12 does not overlap the irradiation of pulse X-rays from the X-ray emission tube 22 are the periods of pulse X-ray irradiation at the second to fourth frames and the sixth frame from the X-ray emission tube 12. Periods in which the irradiation of pulse X-rays from one tube overlaps at least partly that from the other tube are the periods of pulse X-ray irradiation at the first and fifth frames from the X-ray emission tube 12. The amount-of-blur evaluation value of this image is smaller in a period in which the irradiation of pulse X-rays from one tube does not overlap the irradiation of pulse X-rays from the other tube than in a period in which the irradiation of pulse X-rays from one tube overlaps the irradiation of pulse X-rays from the other tube. This is because not only pulse X-rays irradiated from the X-ray emission tube 12 but also scattered X-rays 32, of the pulse X-rays irradiated from the X-ray emission tube 22, which are scattered by the object 11 strike the X-ray detector 13 to increase the degree of image blur.

Consider the timing at which the standard deviation of an image becomes maximum, that is, the amount of blur becomes minimum, based on the analysis result in FIG. 5A. It is possible to set, as this timing, the irradiation timing of pulse X-rays from the X-ray emission tube 12 which is set by an X-ray controller 16 based on one of the irradiation timings of pulse X-rays at the second to fourth frames and the sixth frame from the X-ray emission tube 12. In the case shown in FIG. 4C, the irradiation timing set by the X-ray controller 16 is the timing after the lapse of a time equal to an integer multiple of a period T from the irradiation timing of pulse X-rays at the third frame. Pulse X-rays are then irradiated to determine the irradiation timing of X-rays at the first to sixth frames (the left side of a chain double-dashed line 401 in FIGS. 4A to 4D). In practice, therefore, the irradiation of pulse X-rays from the X-ray emission tube 12, which is set by the X-ray controller 16, is controlled to irradiate pulse X-rays at the seventh frame (the right side of the chain double-dashed line 401 in FIGS. 4A to 4D). As shown in FIG. 4D, the readout circuit 14 reads out an electric signal as image information. That is, the irradiation of pulse X-rays from the X-ray emission tube 12 and the irradiation of pulse X-rays from the X-ray emission tube 22 are alternately and synchronously controlled at the seventh and subsequent frames, and the readout circuit 14 and the readout circuit 24 alternately read out image information of the object 11 (FIGS. 4B and 4D).

Even during bi-plane X-ray imaging at the seventh and subsequent frames described above, an image analyzer 15 may continue to calculate the amount-of-blur evaluation amount of an image at each frame. If the variation of the amount-of-blur evaluation value falls within a predetermined value, it is determined that the irradiation timing of pulse X-rays from the X-ray emission tube 22 has not changed, and the irradiation timing of pulse X-rays from the X-ray emission tube 12 remains unchanged. If the variation of the amount-of-blur evaluation value exceeds the predetermined value, it is determined that the irradiation timing of pulse X-rays from the X-ray emission tube 22 has changed, and an irradiation timing is set for pulse X-rays from the X-ray emission tube 12.

According to this embodiment, it is possible to perform imaging equivalent to that performed by a conventional bi-plane radiation imaging apparatus by using a combination of two independent radiation imaging apparatus including one type of imaging systems. In addition, the radiation imaging apparatus to be combined need not necessarily be manufactured by the same manufacturer, and can be combined and used independently of the manufacturers. This facilitates upgrading from a single imaging apparatus to a bi-plane radiation imaging apparatus and allows easy switching between single-plane radiation imaging and bi-plane radiation imaging, thereby broadening the range of choices of imaging systems.

In this embodiment, no reference is made to scattered X-rays generated in the process of X-ray imaging using a single imaging system because they are not a factor that is directly relevant to the present invention. For example, of the pulse X-rays irradiated from the X-ray emission tube 12, no reference is made to X-rays which are scattered by the object 11 and strike the X-ray detector 13.

### Third Embodiment

Embodiments of the present invention have been described above. However, the present invention is not limited to these embodiments and various changes and modifications can be made.

For example, in the first embodiment, no reference is made to the detection gain (detection sensitivity) of the X-ray detector, which is set as the amplification value (sensitivity) of an electric signal, and the readout gain (readout sensitivity) of the readout circuit. This embodiment may include a gain switch 17 which can switch the magnitudes of the detection gain (detection sensitivity) and readout gain (readout sensitivity) so as to make the switch function as a gain switching unit (sensitivity switching unit). For example, the value of the gain (sensitivity) in a period in which an X-ray emission tube 12 irradiates no pulse X-rays is set to be larger than that in a period in which the X-ray emission tube 12 irradiates pulse X-rays. This arrangement can detect the presence/absence of weak scattered X-rays 32 more accurately.

The above first embodiment has exemplified the case in which an irradiation time and irradiation timing are set for pulse X-rays from the X-ray emission tube 12 from a state in which only the X-ray emission tube 22 irradiates pulse X-rays (first radiation) without causing the X-ray emission tube 12 to irradiate pulse X-rays (second radiation). However, the method of setting an irradiation timing for pulse X-rays from the X-ray emission tube 12 when the irradiation conditions for pulse X-rays from the X-ray emission tube 22 are known is not limited to the method exemplified by the first embodiment. For example, it is possible to set an irradiation timing for pulse X-rays from the X-ray emission tube 12 from the state in which the X-ray emission tube 12 and the X-ray emission tube 22 irradiate pulse X-rays. More specifically, as in the second embodiment, irradiation conditions for pulse X-rays from the X-ray emission tube 12 are set to be the same as those for pulse X-rays from the X-ray emission tube 22. A bi-plane X-ray imaging apparatus including an X-ray imaging apparatus 10 and an X-ray imaging apparatus 20 performs X-ray imaging at an arbitrary X-ray irradiation timing. In this case, the readout circuit 14 repeatedly reads out image information in the first and second readout modes as in the case of the fourth and subsequent frames in FIGS. 4A to 4D in the first embodiment. As in the case shown in FIG. 4C in the second embodiment, only the irradiation interval of pulse X-rays from the X-ray emission tube 12 is gradually increased. This makes it possible to detect the irradiation timing of pulse X-rays irradiated from the X-ray emission tube 22 as the readout result of image information by a readout circuit 14 in the second readout mode. An image analyzer 15 predicts the irradiation timing of pulse X-rays (first radiation) irradiated from the X-ray emission tube 22 from the readout result of image information by the readout circuit 14. An X-ray controller 16 can set an irradiation timing for pulse X-rays (second radiation) from the X-ray emission tube 12 based on the predicted X-ray irradiation timing so as to prevent the irradiation of pulse X-rays from the X-ray emission tube 12 from overlapping that from the X-ray emission tube 22.

In addition, the above second embodiment has exemplified the case in which only the irradiation interval of pulse X-rays from the X-ray emission tube 12 is gradually increased to produce a period in which the irradiation of pulse X-rays from the X-ray emission tube 12 overlaps the irradiation of pulse X-rays from the X-ray emission tube 22 and a period in which the irradiation of pulse X-rays from the X-ray emission tube 12 does not overlap the irradiation of pulse X-rays from the X-ray emission tube 22. However, a method of producing such states is not limited to the above method. For example, the irradiation interval of pulse X-rays from the X-ray emission tube 12 may be set to a constant value other than an integer multiple of the irradiation interval (T in the second embodiment) of pulse X-rays from the X-ray emission tube 22.

The second embodiment described above uses the amount-of-blur evaluation value of an image as the analysis result of image information by the image analyzer 15. However, the analysis technique to be used is not limited to this. If, for example, the readout circuit 14 reads out image information in the same manner as in the second readout mode in the first embodiment, readout image information is obtained as information indicating the total amount of X-rays striking an X-ray detector 13 instead of image information. Referring to FIG. 5B, periods in which the irradiation of pulse X-rays from the X-ray emission tube 12 does not overlap that from the X-ray emission tube 22 correspond to the second to fourth frames and the sixth frame. Periods in which the irradiation of pulse X-rays from the X-ray emission tube 12 overlaps that from the X-ray emission tube 22 correspond to the first and fifth frames. This total amount of X-rays is larger in periods in which the irradiation of X-rays from the X-ray emission tube 12 overlaps the irradiation of X-rays from the X-ray emission tube 22 than in periods in which the irradiation of X-rays from the X-ray emission tube 12 does not overlap the irradiation of X-rays from the X-ray emission tube 22 (FIG. 5B). This is because the scattered X-rays 32, of the pulse X-rays irradiated from the X-ray emission tube 22, which are scattered by the object 11 also strike the X-ray detector 13. Referring to FIG. 5B, the timings at which the total amount of X-rays becomes minimum correspond to the second to fourth frames and the sixth frame. The X-ray controller 16 may set an irradiation timing for pulse X-rays from the X-ray emission tube 12 based on one of the irradiation timings of pulse X-rays at which the total amount of X-rays becomes minimum.

The above first and second embodiments have exemplified the case in which the irradiation of pulse X-rays from the X-ray emission tube 12 in the X-ray imaging apparatus 10 and the irradiation of X-ray pulses from the X-ray emission tube 22 in the X-ray imaging apparatus 20 are alternately and synchronously controlled. However, the pattern of synchronous control of pulse X-ray irradiation to be used is not limited to this as long as the irradiation time and irradiation timing of pulse X-rays from the X-ray emission tube 22 can be predicted by using the method according to the present invention. For example, it is possible to make the X-ray emission tube 12 and the X-ray emission tube 22 irradiate pulse X-rays at almost the same irradiation timing.

The first and second embodiments do not depend on the relative positional relationship between the X-ray imaging apparatus 10 as a front-surface imaging system and the X-ray imaging apparatus 20 as a side-surface imaging system as long as the scattered X-rays 32 strike the X-ray detector 13.

In the first and second embodiments, the processing in the X-ray imaging apparatus 10 may be implemented by programs installed in a computer. Note that it is possible to provide these programs by storing them in a recording medium such as a CD-ROM as well as via a communication unit such as a network.

According to this embodiment, it is possible to perform imaging equivalent to that performed by a conventional bi-plane radiation imaging apparatus by using a combination of two independent radiation imaging apparatus including one type of imaging systems. In addition, the radiation imaging apparatus to be combined need not necessarily be manufactured by the same manufacturer, and can be combined and used independently of the manufacturers. This facilitates upgrading from a single imaging apparatus to a bi-plane radiation imaging apparatus and allows easy switching between single-plane radiation imaging and bi-plane radiation imaging, thereby broadening the range of choices of imaging systems.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-132428, filed Jun. 1, 2009, which is hereby incorporated by reference herein in its entirety.

What is claimed is:

1. A radiation imaging apparatus which captures a radiation image by detecting radiation transmitted through an object, the apparatus comprising:
a first radiation generating unit adapted to irradiate the object with first radiation from a first direction;
a second radiation generating unit adapted to irradiate the object with second radiation from a second direction;
a first radiation detection unit adapted to detect the first radiation irradiated by said first radiation generating unit and transmitted through the object;
a second radiation detection unit adapted to detect the second radiation irradiated by said second radiation generating unit and transmitted through the object and the first radiation irradiated by said first radiation generating unit and scattered by the object;
a readout unit adapted to read out image information indicating a result of imaging of the object from said second radiation detection unit;
an image analysis unit adapted to analyze the image information read out by said readout unit; and
a radiation control unit adapted to control an irradiation timing of the second radiation by said second radiation generating unit based on an analysis result obtained by said image analysis unit.

2. The apparatus according to claim 1, wherein said second radiation detection unit detects the radiation during a period in which said second radiation generating unit does not irradiate the second radiation and said first radiation generating unit irradiates the first radiation, and
said image analysis unit analyzes presence/absence of the first radiation scattered by the object during the period.

3. The apparatus according to claim 1, wherein the radiation imaging apparatus further comprises a sensitivity switching unit adapted to switch magnitudes of values of sensitivities including a detection sensitivity of said second radiation detection unit and a readout sensitivity with which said readout unit reads out the image information as an electric signal, and
said sensitivity switching unit sets a larger value of the detection sensitivity and a larger value of the readout sensitivity in a period in which said second radiation generating unit does not irradiate the second radiation and said first radiation generating unit irradiates the first radiation than in a period in which the second radiation is irradiated.

4. The apparatus according to claim 1, wherein said image analysis unit obtains an amount-of-blur evaluation value which evaluates an amount of blur of the image information as the analysis result, and
an irradiation timing of the second radiation controlled by said radiation control unit is controlled based on an irradiation timing of the first radiation irradiated upon detection of the image information when the amount-of-blur evaluation value becomes maximum.

5. The apparatus according to claim 4, wherein the irradiation timing of the second radiation controlled by said radiation control unit is a timing after a lapse of a time equal to an integer multiple of an irradiation period of the first radiation irradiated by said first radiation generating unit from an irradiation timing of the second radiation irradiated upon detection of the image information when the amount-of-blur evaluation value becomes maximum.

6. The apparatus according to claim 1, wherein the analysis result obtained by said image analysis unit is a total amount of the first radiation and the second radiation, and
an irradiation timing of the second radiation controlled by said radiation control unit is a timing controlled based on an irradiation timing of the first radiation irradiated upon detection of the image information when the total amount of the first radiation and the second radiation becomes minimum.

7. The apparatus according to claim 6, wherein the irradiation timing of the second radiation controlled by said radiation control unit is a timing after a lapse of a time equal to an integer multiple of an irradiation period of the first radiation by said first radiation generating unit from an irradiation timing of the second radiation irradiated upon detection of the image information when the total amount of the first radiation and the second radiation becomes minimum.

8. The apparatus according to claim 1, wherein the irradiation timing of the second radiation controlled by said radiation control unit is set when a variation of the analysis result obtained by said image analysis unit exceeds a predetermined constant value.

9. A radiation imaging method for a radiation imaging apparatus which captures a radiation image by detecting radiation transmitted through an object, the method comprising:
a first radiation generating step of irradiating the object with first radiation from a first direction;
a second radiation generating step of irradiating the object with second radiation from a second direction;
a first radiation detection step of detecting the first radiation irradiated in the first radiation generating step and transmitted through the object;
a second radiation detection step of detecting the second radiation irradiated in the second radiation generating step and transmitted through the object and the first radiation irradiated in the first radiation generating step and scattered by the object;
a readout step of reading out image information indicating a result of imaging of the object detected in the second radiation detection step;
an image analysis step of analyzing the image information read out in the readout step; and
a radiation control step of controlling an irradiation timing of the second radiation in the second radiation generating step based on an analysis result obtained in the image analysis step.

10. A program for causing a computer to execute a radiation imaging method defined in claim 9.
